(19) United States
(12) Patent Application Publication
(10) Pub. No.: US 2018/0004394 A1
(43) Pub. Date: Jan. 4, 2018

(54) METHOD AND APPARATUS FOR DISPLAYING WIFI SIGNAL ICON, AND MOBILE TERMINAL

(71) Applicant: Beijing Xiaomi Mobile Software Co., Ltd., Beijing (CN)

(72) Inventors: Shuo LIU, Beijing (CN); Dasong LI, Beijing (CN); Shan YAN, Beijing (CN)

(73) Assignee: Beijing Xiaomi Mobile Software Co., Ltd.

(21) Appl. No.: 15/486,588

(22) Filed: Apr. 13, 2017

(30) Foreign Application Priority Data
Jun. 30, 2016 (CN) 201610509431.X

(51) Int. Cl. G06F 3/0481; H04W 12/02; G06F 3/0482; H04W 84/12; H04W 88/02

(52) U.S. Cl. CPC G06F 3/04817; H04W 12/02; G06F 3/0482; H04W 88/02; H04W 84/12

(57) ABSTRACT

The present disclosure relates to a method for displaying a WiFi signal icon on a mobile terminal. The method includes determining a security level of a current WiFi network, marking a WiFi signal icon according to a color corresponding to the security level, and displaying the marked WiFi signal icon on the mobile terminal.

### CROSS-REFERENCE TO RELATED APPLICATION

This application is based upon and claims priority to Chinese Patent Application No. 201610509431.X, filed on Jun. 30, 2016, the entire contents of which are incorporated herein by reference.

### TECHNICAL FIELD

The present disclosure generally relates to the technical field of mobile communication, and more particularly, to a method and device for displaying a WiFi signal icon on a mobile terminal and the mobile terminal.

### BACKGROUND

With rapid development of communication technology, more and more functions are provided by mobile terminals, such as mobile phones. Users can not only make phone calls and send short messages, but also can make payments, store personal privacy information, and the like. Thereby, mobile terminals have become an indispensable part of users' daily life.

Mobile terminals have a WiFi (Wireless Fidelity) connection function. After a mobile terminal connects to a WiFi access point, the mobile terminal may display a WiFi signal icon, for example on an upper side of its screen, to indicate that the mobile terminal has been connected to a WiFi network. However, a same icon is usually displayed regardless the mobile terminal connects to a WiFi network at home, in the office or in a public circumstance.

### SUMMARY

According to a first aspect of embodiments of the present disclosure, there is provided a method for displaying a WiFi signal icon on a mobile terminal. The method includes determining a security level of a current WiFi network, marking a WiFi signal icon according to a color corresponding to the security level, and displaying the marked WiFi signal icon on the mobile terminal.

According to a second aspect of embodiments of the present disclosure, there is provided a mobile terminal for displaying a WiFi signal icon on the mobile terminal. The mobile terminal includes a processor and a memory for storing instructions executable by the processor. The processor is configured to determine a security level of a current WiFi network, to mark a WiFi signal icon according to a color corresponding to the security level, and to display the marked WiFi signal icon on the mobile terminal.

According to a third aspect of embodiments of the present disclosure, there is provided a non-transitory computer-readable storage medium having stored therein instructions that, when executed by a processor in a mobile terminal, cause the mobile terminal to perform a method for displaying a WiFi signal icon on the mobile terminal. The method includes determining a security level of a current WiFi network, marking a WiFi signal icon according to a color corresponding to the security level, and displaying the marked WiFi signal icon on the mobile terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for displaying a WiFi signal icon on a mobile terminal, according to an exemplary embodiment.

FIG. 2 is a flow chart of a method for displaying a WiFi signal icon on a mobile terminal, according to another exemplary embodiment.

FIG. 3 is a flow chart of a method for displaying a WiFi signal icon on a mobile terminal, according to further another exemplary embodiment.

FIG. 4 is a flow chart of a method for displaying a WiFi signal icon on a mobile terminal, according to still another exemplary embodiment.

FIG. 5 is a block diagram of an apparatus for displaying a WiFi signal icon on a mobile terminal, according to an exemplary embodiment.

FIG. 6 is a block diagram of an apparatus for displaying a WiFi signal icon on a mobile terminal, according to another exemplary embodiment.

FIG. 7 is a block diagram of an apparatus for displaying a WiFi signal icon on a mobile terminal, according to yet another exemplary embodiment.

FIG. 8 is a block diagram of an apparatus for displaying a WiFi signal icon on a mobile terminal, according to still another exemplary embodiment.

FIG. 9 is a block diagram of an apparatus for displaying a WiFi signal icon on a mobile terminal, according to further another exemplary embodiment.

FIG. 10 is a block diagram of an apparatus for displaying a WiFi signal icon on a mobile terminal, according to further another exemplary embodiment.

FIG. 11 is a block diagram of a mobile terminal, according to an exemplary embodiment.

Specific embodiments in this disclosure have been shown by way of example in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely exemplary apparatuses and methods consistent with aspects related to the invention as recited in the appended claims.

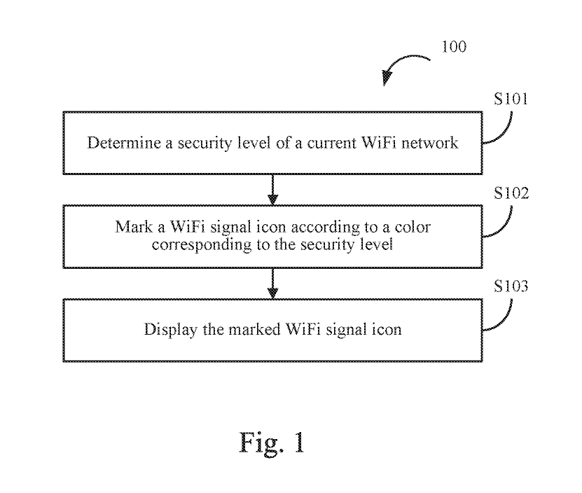

FIG. 1 is a flow chart of a method 100 for displaying a WiFi signal icon on a mobile terminal, according to an exemplary embodiment. As shown in FIG. 1, the method 100 may be applicable to a mobile terminal. The mobile terminal may be a hardware device having various operating systems, such as a mobile phone, a tablet computer, a personal digital assistant, and an E-book. The method 100 may include the following steps.

In step S101, a security level of a current WiFi network is determined.

During a connection to a WiFi network by a mobile terminal, before the mobile terminal is connected to the current WiFi network, the mobile terminal may acquire surrounding connectable WiFi networks via a scanning manner, and rank WiFi networks having security levels preset by a user. The mobile terminal may further rank WiFi networks having no security levels set by a user according to an existing WiFi ranking manner, for example, an alphabetical order.

It should be understood, for the WiFi networks having no security levels set by the user, the mobile terminal may set the corresponding WiFi networks to a preset security level. A color corresponding to the preset security level may be white, i.e., the color of all the WiFi signal icons used by the WiFi networks having not set with security levels by the user is white.

The security levels of the WiFi networks may be provided by default in the mobile terminal, or may be set by a user according to requirements. For example, the security level may be categorized as “very safe”, “safe”, “normal”, etc., or may be set to “security level 1”, “security level 2”, “security level 3”, “security level 4”, and the like. The security level may be set particularly in combination with application scenarios, and is not restricted by the present disclosure.

After the mobile terminal is connected to the current WiFi network, a security level corresponding to the current WiFi network may be identified from a prestored corresponding relationship between networks and security levels.

In exemplary embodiments, the prestored corresponding relationship between networks and security levels is generated according to security levels set for the used WiFi networks by the user.

For example, during usage of a smart phone, a WiFi network at home has a name A. If the user is using the WiFi network at home and sets a security level of the WiFi network at home to “very safe”, the smart phone will save the network name A of the WiFi network at home and its corresponding security level (i.e., “very safe”) into the corresponding relationship between networks and security levels.

For another example, when the user visits a friend and uses a WiFi network at home of the friend, the user may set a security level of the WiFi network at home of the friend to “safe”. The smart phone will save the corresponding network name and its corresponding security level into the corresponding relationship between networks and security levels according to the user's setting.

Still for another example, when the user connects to a WiFi network in a public place, the user may set a security level of the WiFi network in the public place, to which the smart phone is connected, to be “normal”. The smart phone will save the corresponding network name and its corresponding security level into the corresponding relationship between networks and security levels according to the user's setting.

In addition, in the exemplary embodiments of the present disclosure, after searching for the security level corresponding to the current WiFi network, if no security level corresponding to the current WiFi network is identified from the prestored corresponding relationship between networks and security levels, a current security level input box may be displayed. The current WiFi network and a current security level are associatively stored according to an instruction input by the user. The instruction input by the user includes the current security level.

In step S102, a WiFi signal icon is marked according to a color corresponding to the security level.

After determining the security level of the current WiFi network of the mobile terminal, the color corresponding to the security level may be determined according to the corresponding relationship between security levels and colors saved in the mobile terminal. The WiFi signal icon is marked by the color corresponding to the security level.

In some embodiments, the corresponding relationship between security levels and colors may be default in the mobile terminal, or may be set by a user according to requirements. That is, when using the mobile terminal, the user may freely set the corresponding relationship between security levels and colors according to requirements.

In step S103, the marked WiFi signal icon is displayed.

For example, when it is determined that the security level of the current WiFi network of the mobile terminal is “normal”, and the color corresponding to this security level is yellow, the color of the WiFi signal icon displayed on a top portion of the mobile terminal is yellow. A user may determine via the color of the WiFi signal icon that the security level of the WiFi network connected by the mobile terminal is “normal”. At this time, the user may know the security level of the WiFi network currently connected by the mobile terminal via the color of the WiFi signal icon, and perform relevant operations on the mobile terminal according to the security level of the mobile terminal. As a result, private information in the mobile terminal may be prevented from leaking. For example, during payment by inputting an account and a password by a user, in order to avoid leaking of the account and the password, the user may close the WiFi network at first, and use, e.g., a cellular data traffic for payment, thereby ensuring the safety of his/her account.

In the method 100, the mobile terminal determines a security level of a current WiFi network, marks a WiFi signal icon by applying a color corresponding to the security level; and displays the marked WiFi signal icon. In this way, the WiFi signal icon is displayed with a color corresponding to a security level of the WiFi network, which facilitates a user to know the security level of the currently connected network via the color of the WiFi network icon, and further facilitates the user to perform relevant operations on the mobile terminal according to the security level of the network. As a result, leaking of private information in the mobile terminal can be prevented.

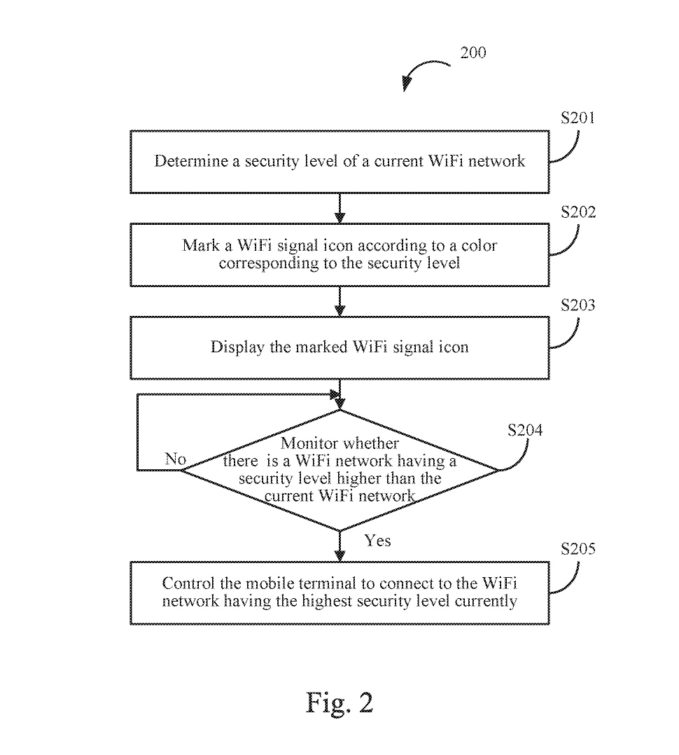

FIG. 2 is a flow chart of a method 200 for displaying a WiFi signal icon on a mobile terminal, according to another exemplary embodiment. As shown in FIG. 2, the method 200 may be applicable to a mobile terminal. The mobile terminal may be a hardware device having various operating systems, such as a mobile phone, a tablet computer, a personal digital assistant, and an E-book. The method 200 for displaying a WiFi signal icon on a mobile terminal may include the following steps.

In step S201, a security level of a current WiFi network is determined.

During a connection to a WiFi network by a mobile terminal, before the mobile terminal is connected to the current WiFi network, the mobile terminal may acquire surrounding connectable WiFi networks via a scanning manner, rank the WiFi networks having security levels preset by a user, and rank the WiFi networks having no security levels set by a user according to an existing WiFi ranking manner. For example, the WiFi networks having no security levels set by the user may be ranked according to an alphabetical order.

In some embodiments, for WiFi networks having no security levels set by a user, the mobile terminal may set the corresponding WiFi networks to a preset security level. A color corresponding to the preset security level may be white, i.e., the color of all the WiFi signal icons used by the WiFi networks having not set with security levels by the user is white.

The security levels of the WiFi networks may be provided by default in the mobile terminal, or may be set by the user according to requirements. For example, the security level may be set to “very safe”, “safe”, or “normal”, or may be set to “security level 1”, “security level 2”, “security level 3”, “security level 4”, or the like. The security level may be set particularly in combination with application scenarios, and is not limited by the present disclosure.

After the mobile terminal is connected to the current WiFi network, a security level corresponding to the current WiFi network may be identified from a prestored corresponding relationship between networks and security levels.

In some embodiments, the prestored corresponding relationship between networks and security levels is generated according to security levels set for the used WiFi network by the user.

For example, during usage of a smart phone, a WiFi network at home has a name A. If the user is using the WiFi network at home, a security level of the WiFi network at home may set to “very safe”. The smart phone will save the network name A of the WiFi network at home and its corresponding security level (i.e., “very safe”) into the corresponding relationship between networks and security levels.

For another example, when the user visits a friend and uses a WiFi network at home of the friend, the user may set a security level of the WiFi network at home of the friend to “safe”. The smart phone will save the corresponding network name and its corresponding security level (i.e., “safe”) into the corresponding relationship between networks and security levels according to the user's setting.

Further for example, when the user connects to a WiFi network in a public place, the user may set a security level of the WiFi network in the public place, to which the smart phone is connected, to “normal”. The smart phone will save the corresponding network name and its corresponding security level (i.e., “normal”) into the corresponding relationship between networks and security levels according to the user's setting.

In addition, in the exemplary embodiments of the present disclosure, after searching for the security level corresponding to the current WiFi network, if no security level corresponding to the current WiFi network is identified from the prestored corresponding relationship between networks and security levels, a current security level input box may be displayed. The current WiFi network and a current security level are associatively stored according to an instruction input by a user. The instruction input by the user includes the current security level.

In step S202, a WiFi signal icon is marked according to a color corresponding to the security level.

After determining the security level of the current WiFi network of the mobile terminal, a color corresponding to the security level may be determined according to a corresponding relationship between security levels and colors saved in the mobile terminal. The WiFi signal icon is marked by the color corresponding to the security level.

In some embodiments, the corresponding relationship between security levels and colors may be default in the mobile terminal, or may be set by a user according to requirements. That is, when using the mobile terminal, the user may freely set the corresponding relationship between security levels and colors according to requirements.

In step S203, the marked WiFi signal icon is displayed.

For example, when it is determined that the security level of the current WiFi network of the mobile terminal is “normal”, and the color corresponding to this security level is yellow, the color of the WiFi signal icon displayed on a top portion of the mobile terminal is yellow. The user may determine that the security level of the WiFi network connected by the mobile terminal is “normal” via the color of the WiFi signal icon. At this time, the user may know the security level of the WiFi network currently connected by the mobile terminal via the color of the WiFi signal icon, and perform relevant operations on the mobile terminal according to the security level of the mobile terminal. As a result, leaking of private information in the mobile terminal can be prevented. For example, during payment by inputting an account and a password by a user, in order to avoid leaking of the account and the password, the user may close the WiFi network at first, and use the data traffic for payment, thus, ensuring the safety of his/her account.

In step S204, it is monitored whether there is a WiFi network having a security level higher than the security lever of the current WiFi network.

In step S205, if there is a WiFi network having the security level higher than the security level of the current WiFi network, the mobile terminal is controlled to connect to the WiFi network having the highest security level currently.

In some embodiments, after the mobile terminal is connected to the WiFi network having the highest security level currently, the mobile terminal may display the WiFi network icon with a color corresponding to the security level of the WiFi network having the highest security level currently.

For example, before updating, the color of the WiFi signal icon displayed at an upper portion of a screen of the mobile terminal is white. Given that there is a WiFi network with a security level higher than the security level of the current WiFi network and the network name of the WiFi network having the highest security level is B, if the mobile terminal determines that the security level of the WiFi network having the network name B is 3, and the color of the WiFi signal icon corresponding to the security level is determined as green according to the security level 3, then the mobile terminal is controlled to automatically connect to the WiFi network having the network name B, and a green WiFi signal icon is displayed at the upper portion of the screen of the mobile terminal. As such, the user can determine the security level of the WiFi network connected by the mobile terminal via the WiFi signal icon, which facilitates the user to perform relevant operations on the mobile terminal according to the security level.

In the method 200, after the mobile terminal connects to the current WiFi network, if the presence of a WiFi network having a security level higher than the security level of the current WiFi network is detected, the mobile terminal is controlled to connect to the WiFi network having the highest security level currently. Thereby, the smart switching of the WiFi networks is automatically realized according to the security levels, and the WiFi network icon is displayed with a color corresponding to the security level of the WiFi network after switching, which facilitates the user to know the security level of the currently connected network via the color of the WiFi network icon, and improves the experience of the user.

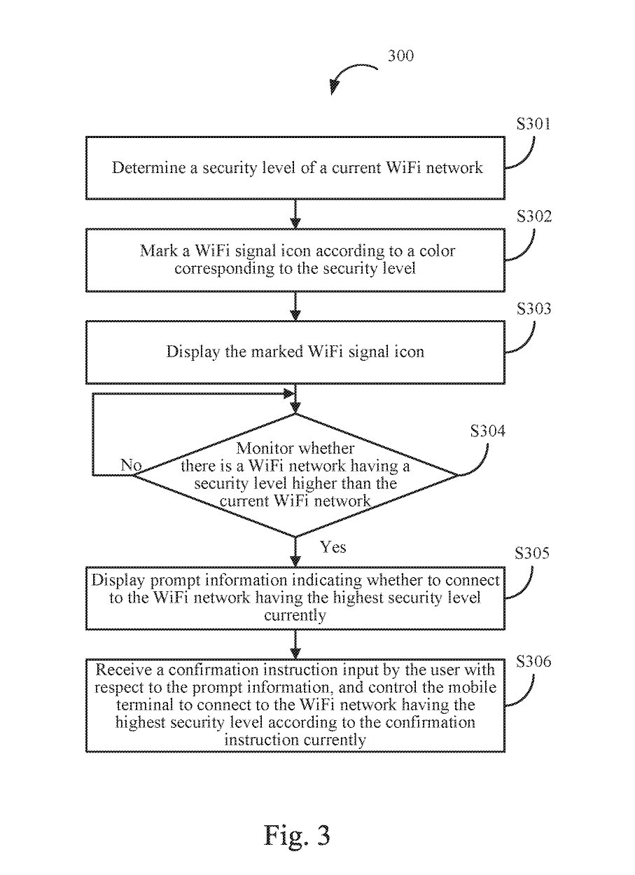

FIG. 3 is a flow chart of a method 300 for displaying a WiFi signal icon on a mobile terminal, according to another exemplary embodiment. As shown in FIG. 3, the method 300 may be applicable to a mobile terminal. The mobile terminal may be a hardware device having various operating systems, such as a mobile phone, a tablet computer, a personal digital assistant, and an E-book. The method 300 for displaying a WiFi signal icon on a mobile terminal may include the following steps.

In step S301, a security level of a current WiFi network is determined.

During a connection to a WiFi network by a mobile terminal, before the mobile terminal is connected to the current WiFi network, the mobile terminal may acquire surrounding connectable WiFi networks via a scanning manner, rank the WiFi networks having security levels preset by a user, and rank the WiFi networks having no security levels set by a user according to an existing WiFi ranking manner. For example, the WiFi networks having no security levels set by the user may be ranked according to an alphabetical order.

In some embodiments, for the WiFi networks having no security levels set by the user, the mobile terminal may set the corresponding WiFi networks to be a preset security level, and a color corresponding to the preset security level may be white, i.e., the color of all the WiFi signal icons used by the WiFi networks having not set with security levels by the user is white.

The security levels of the WiFi networks may be provided by default in the mobile terminal, or may be set by a user according to requirements. For example, the security level may be set to “very safe”, “safe”, or “normal”, or may be set to “security level 1”, “security level 2”, “security level 3”, “security level 4”, or the like. The security level may be set particularly in combination with application scenarios, and is not limited by the present disclosure.

After the mobile terminal is connected to the current WiFi network, a security level corresponding to the current WiFi network may be identified from a prestored corresponding relationship between networks and security levels.

In some embodiments, the prestored corresponding relationship between networks and security levels may be generated according to the security levels set for the used WiFi network by the user.

For example, during usage of a smart phone, a network name of the WiFi network at home has a name A. If the user is using the WiFi network at home, a security level of the WiFi network at home is set to “very safe”. The smart phone will save the network name of the WiFi network at home and its corresponding security level into the corresponding relationship between networks and security levels.

For another example, when the user visits a friend and uses a WiFi network at home of the friend, the user may set a security level of the WiFi network at home of the friend to “safe”. The smart phone will save the corresponding network name and its corresponding security level into the corresponding relationship between networks and security levels according to the user's setting.

Further for example, when the user connects to a WiFi network in a public place, the user may set a security level of the WiFi network in the public place, to which the smart phone is connected, to “normal”. The smart phone will save the corresponding network name and its corresponding security level into the corresponding relationship between networks and security levels according to the user's setting.

In addition, in the exemplary embodiments of the present disclosure, after searching for the security level corresponding to the current WiFi network, if no security level corresponding to the current WiFi network is identified from the prestored corresponding relationship between networks and security levels, a current security level input box may be displayed. The current WiFi network and the current security level are associatively stored according to an instruction input by a user. The instruction input by the user includes the current security level.

In step S302, a WiFi signal icon is marked according to a color corresponding to the security level.

After determining the security level of the current WiFi network of the mobile terminal, the color corresponding to the security level may be determined according to a corresponding relationship between security levels and colors saved in the mobile terminal. The WiFi signal icon is marked by the color corresponding to the security level.

In some embodiments, the corresponding relationship between security levels and colors may be default in the mobile terminal, or may be set by a user according to requirements. That is, when using the mobile terminal, the user may freely set the corresponding relationship between security levels and colors according to requirements.

In step S303, the marked WiFi signal icon is displayed.

For example, when it is determined that the security level of the current WiFi network currently connected by the mobile terminal is “normal”, and the color corresponding to this security level is yellow, the color of the WiFi signal icon displayed on a top portion of the mobile terminal is yellow. As such, the user may determine that the security level of the WiFi network connected by the mobile terminal is “normal” via the color of the WiFi signal icon. At this time, the user may know the security level of the WiFi network currently connected by the mobile terminal via the color of the WiFi signal icon, and perform relevant operations on the mobile terminal according to the security level of the mobile terminal. Accordingly, leaking of private information in the mobile terminal can be prevented. For example, during payment by inputting an account and a password by a user, in order to avoid the leaking of the account and the password, the user may close the WiFi network at first, and use the data traffic for payment, ensuring the safety of his/her account.

In step S304, it is monitored whether there is a WiFi network having a security level higher than the current WiFi network.

In step S305, if there is a WiFi network having the security level higher than the security level of the current WiFi network, prompt information indicating whether to connect to the WiFi network having the highest security level currently is displayed.

In step S306, a confirmation instruction input by the user with respect to the prompt information is received. The mobile terminal is controlled to connect to the WiFi network having the highest security level currently according to the confirmation instruction.

In some embodiments, after the mobile terminal is connected to the WiFi network having the highest security level currently, the mobile terminal may display the WiFi network icon with a color corresponding to the security level of the WiFi network having the highest security level currently.

For example, before updating, the color of the WiFi signal icon displayed at an upper portion of the mobile terminal is white. Given that there is a WiFi network C having a security level higher than the security level of the current WiFi network, if the mobile terminal determines that the security level of the WiFi network C is 2, and the color of the WiFi signal icon corresponding to the security level is determined as yellow according to the Security level 2, then the prompt information indicating whether to connect to the WiFi network C is displayed. If a confirmation instruction input by the user with respect to the prompt information is received, the mobile terminal is controlled to connect to the WiFi network C, and a yellow WiFi signal icon is displayed at the upper portion of the mobile terminal. As such, the user can determine the security level of the WiFi network connected by the mobile terminal via the WiFi signal icon, which facilitates the user to perform relevant operations on the mobile terminal according to the security level.

In the method 300, after the mobile terminal connects to the current WiFi network, if the presence of a WiFi network having a security level higher than the security level of the current WiFi network is detected, the WiFi network having the highest security level is determined. Prompt information of whether to switch to the WiFi network having the highest security level currently is provided to the user. Then the mobile terminal is controlled to connect to the WiFi network having the highest security level currently according to the confirmation instruction of the user with respect to the prompt information, and the WiFi network icon is marked with the color of the WiFi network having the highest security level. As a result, the WiFi network having the highest security level is provided to the user. The switching of the WiFi network is accomplished according to the instruction of the user, and the WiFi network icon is displayed with the color corresponding to the security level of the WiFi network after switching. This facilitates the user to know the security level of the currently connected network via the color of the WiFi network icon, and improves the experience of the user.

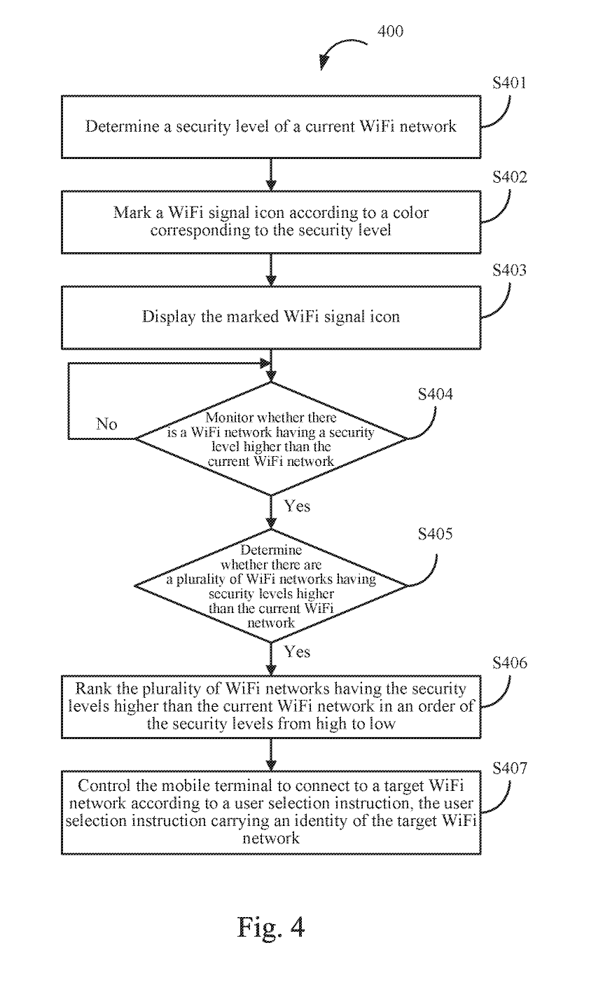

FIG. 4 is a flow chart of a method 400 for displaying a WiFi signal icon on a mobile terminal, according to another exemplary embodiment. As shown in FIG. 4, the method 400 may be applicable to a mobile terminal. The mobile terminal may be a hardware device having various operating systems, such as a mobile phone, a tablet computer, a personal digital assistant, and/or an E-book. The method 400 for displaying a WiFi signal icon on a mobile terminal may include the following steps.

In step S401, a security level of a current WiFi network is determined.

During a connection to a WiFi network by a mobile terminal, before the mobile terminal is connected to the current WiFi network, the mobile terminal may acquire surrounding connectable WiFi networks via a scanning manner, rank the WiFi networks having security levels preset by a user, and rank the WiFi networks having no security levels set by a user according to an existing WiFi ranking manner. For example, the WiFi networks having no security levels set by the user may be ranked according to an alphabetical order.

In some embodiments, for the WiFi networks having no security levels set by the user, the mobile terminal may set the corresponding WiFi networks to be a preset security level. A color corresponding to the preset security level may be white, i.e., the color of all the WiFi signal icons used by the WiFi networks having not set with security levels by the user is white.

The security levels of the WiFi networks may be provided by default in the mobile terminal, or may be set by a user according to requirements. For example, the security level may be set to “very safe”, “safe”, “normal”, etc., or may be set to “security level 1”, “security level 2”, “security level 3”, “security level 4”, and the like. The security level may be set particularly in combination with application scenarios, and is not limited by the present disclosure.

After the mobile terminal is connected to the current WiFi network, a security level corresponding to the current WiFi network may be identified from a prestored corresponding relationship between networks and security levels.

In some embodiments, the prestored corresponding relationship between networks and security levels may be generated according to the security levels set for the used WiFi network by the user.

For example, during usage of a smart phone, a network name of the WiFi network at home has a name A. If the user is using the WiFi network at home, a security level of the WiFi network at home is set to “very safe”. The smart phone will save the network name of the WiFi network at home and its corresponding security level into the corresponding relationship between networks and security levels.

For another example, when the user visits a friend and uses a WiFi network at home of the friend, the user may set the security level of the WiFi network at home of the friend to “safe”. The smart phone will save the corresponding network name and its corresponding security level into the corresponding relationship between networks and security levels according to the user's setting.

Further for example, when the user connects to a WiFi network in a public place, the user may set a security level of the WiFi network in the public place, to which the smart phone is connected, to “normal”. The smart phone will save the corresponding network name and its corresponding security level into the corresponding relationship between networks and security levels according to the user's setting.

In addition, in the exemplary embodiments of the present disclosure, after searching the security level corresponding to the current WiFi network, if no security level corresponding to the current WiFi network is identified from the prestored corresponding relationship between networks and security levels, a current security level input box is displayed. The current WiFi network and the current security level are associatively stored according to an instruction input by a user. The instruction input by the user includes the current security level.

In step S402, a WiFi signal icon is marked according to a color corresponding to the security level.

After determining the security level of the current WiFi network of the mobile terminal, the color corresponding to the security level may be determined according to a corresponding relationship between security levels and colors saved in the mobile terminal. The WiFi signal icon is marked by the color corresponding to the security level.

In some embodiments, the corresponding relationship between security levels and colors may be default in the mobile terminal, or may be set by the user according to requirements. That is, when using the mobile terminal, the user may freely set the corresponding relationship between security levels and colors according to requirements.

In step S403, the marked WiFi signal icon is displayed.

For example, when it is determined that the security level of the current WiFi network of the mobile terminal is “normal”, and the color corresponding to this security level is yellow, the color of the WiFi signal icon displayed on a top portion of the mobile terminal is yellow. As such, a user may determine that the security level of the WiFi network connected by the mobile terminal is “normal” via the color of the WiFi signal icon. At this time, the user may know the security level of the WiFi network currently connected by the mobile terminal via the color of the WiFi signal icon, and perform relevant operations on the mobile terminal according to the security level of the mobile terminal. As a result, leaking of private information in the mobile terminal can be prevented. For example, during payment by inputting an account and a password by a user, in order to avoid the leaking of the account and the password, the user may close the WiFi network at first, and use the data traffic for payment, ensuring the safety of his/her account.

In step S404, it is monitored whether there is a WiFi network having a security level higher than the current WiFi network.

In step S405, if there is a WiFi network having the security level higher than the security level of the current WiFi network, it is further determined whether there are a plurality of WiFi networks having security levels higher than the security level of the current WiFi network.

In step S406, if there are a plurality of WiFi networks having security levels higher than the security level of the current WiFi network, the plurality of WiFi networks having the security levels higher than the security level of the current WiFi network are ranked in an order of the security levels from high to low.

In some embodiments, if there is a WiFi network having a security level higher than the security level of the current WiFi network, the WiFi network having the security level higher than the security level of the current WiFi network is used as the updated current WiFi network, and the mobile terminal is controlled to connect to the updated current WiFi network.

In step S407, the mobile terminal is controlled to connect to a target WiFi network according to a user selection instruction. The user selection instruction includes an identity of the target WiFi network. The target WiFi network may be one of the plurality of networks having the security level higher than the security level of the current network, or may be the current network, which is based on the user selection instruction.

In some embodiments, after the mobile terminal is connected to the updated target WiFi network, the mobile terminal may display a WiFi network icon with a corresponding color according to the security level of the updated target WiFi network.

In the method 400, after a mobile terminal connects to a current WiFi network, if the presence of a plurality of WiFi networks having security levels higher than the security level of the current WiFi network is detected, the plurality of WiFi networks are ranked in an order of the security levels from high to low. The mobile terminal is controlled to connect to a target WiFi network according to a user selection instruction. A color corresponding to the security level of the target WiFi network selected by the user is determined, and the WiFi signal icon is marked with the color. The WiFi signal icon with the corresponding color is displayed on the mobile terminal. Thereby, the plurality of WiFi networks having security levels higher than the security level of the current WiFi network are provided to the user, and switching of WiFi network is accomplished according to the selection of the user. The WiFi network icon is displayed with the corresponding color according to the security level of the WiFi network after switching. This facilitates the user to know the security level of the currently connected network via the color of the WiFi network icon, and improves the experience of the user.

Corresponding to the exemplary embodiments of the methods for displaying a WiFi signal icon on a mobile terminal, the present disclosure also provides exemplary embodiments of an apparatus for displaying a WiFi signal icon on a mobile terminal.

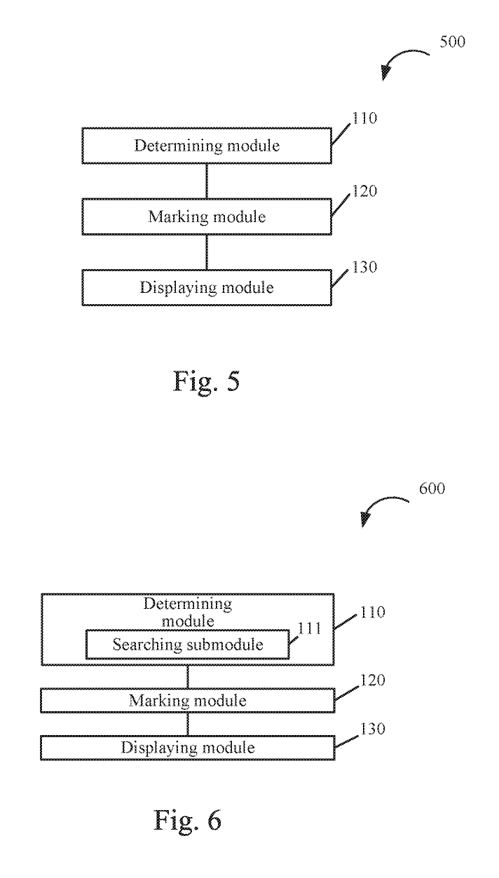

FIG. 5 is a block diagram of an apparatus 500 for displaying a WiFi signal icon on a mobile terminal, according to an exemplary embodiment. The apparatus 500 for displaying a WiFi signal icon on a mobile terminal may be implemented through software, hardware, or a combination thereof. As shown in FIG. 5, the apparatus 500 may include a determining module 110, a marking module 120, and a displaying module 130.

The determining module 110 is configured to determine a security level of a current WiFi network.

The marking module 120 is configured to mark a WiFi signal icon according to a color corresponding to the security level.

The displaying module 130 is configured to display the marked WiFi signal icon.

The apparatus 500 for displaying a WiFi signal icon on a mobile terminal provided by the present exemplary embodiment determines a security level of a current WiFi network, marks a WiFi signal icon by applying a color corresponding to the security level, and displays the marked WiFi signal icon. In this way, the WiFi signal icon is displayed with a color corresponding to the security level of the WiFi network, which facilitates the user to know the security level of the currently connected network via the color of the WiFi network icon, and further facilitates the user to perform relevant operations on the mobile terminal according to the security level of the network. As a result, leaking of private information in the mobile terminal can be prevented.

FIG. 6 is a block diagram of an apparatus 600 for displaying a WiFi signal icon on a mobile terminal, according to another exemplary embodiment. This exemplary embodiment is based on the above-described exemplary embodiment shown in FIG. 5. As shown in FIG. 6, the determining module 110 may include a searching submodule 111.

The searching submodule 111 is configured to search for a security level corresponding to the current WiFi network from a prestored corresponding relationship between networks and security levels.

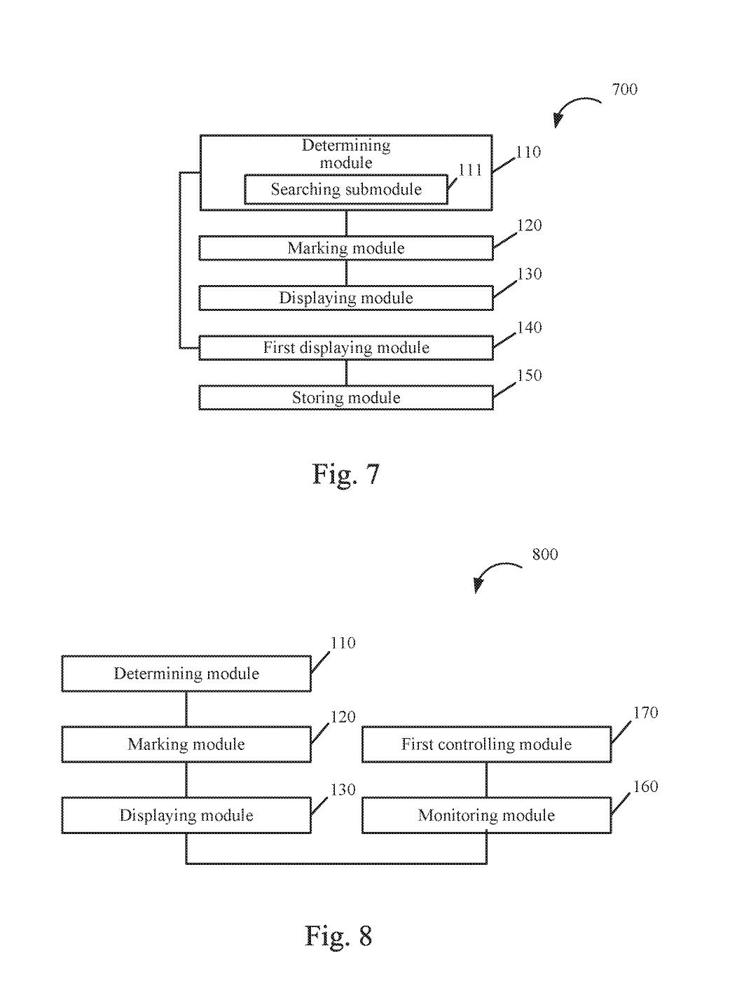

FIG. 7 is a block diagram of an apparatus 700 for displaying a WiFi signal icon on a mobile terminal, according to another exemplary embodiment. This exemplary embodiment is based on the above-described exemplary embodiment shown in FIG. 6. The above apparatus 700 may further include a first displaying module 140 and a storing module 150.

The first displaying module 140 is configured to, when the security level corresponding to the current WiFi network is not found, display a current security level input box.

The storing module 150 is configured to store the current WiFi network and the current security level associatively according to a user input instruction. The user input instruction includes the current security level.

FIG. 8 is a block diagram of an apparatus 800 for displaying a WiFi signal icon on a mobile terminal, according to another exemplary embodiment. This exemplary embodiment is based on the above-described exemplary embodiment shown in FIG. 5. As shown in FIG. 8, the above apparatus 800 may further include a monitoring module 160 and a first controlling module 170.

The monitoring module 160 is configured to monitor whether there is a WiFi network having a security level higher than the security level of the current WiFi network.

The first controlling module 170 is configured to, when there is a WiFi network having the security level higher than the security level of the current WiFi network, control the mobile terminal to connect to the WiFi network having the highest security level currently.

In some embodiments, the monitoring module 160 and the first controlling module 170 in the above-described apparatus 800 embodiment shown in FIG. 8 may also be included in the apparatus 600 or 700, which is not limited by the present disclosure.

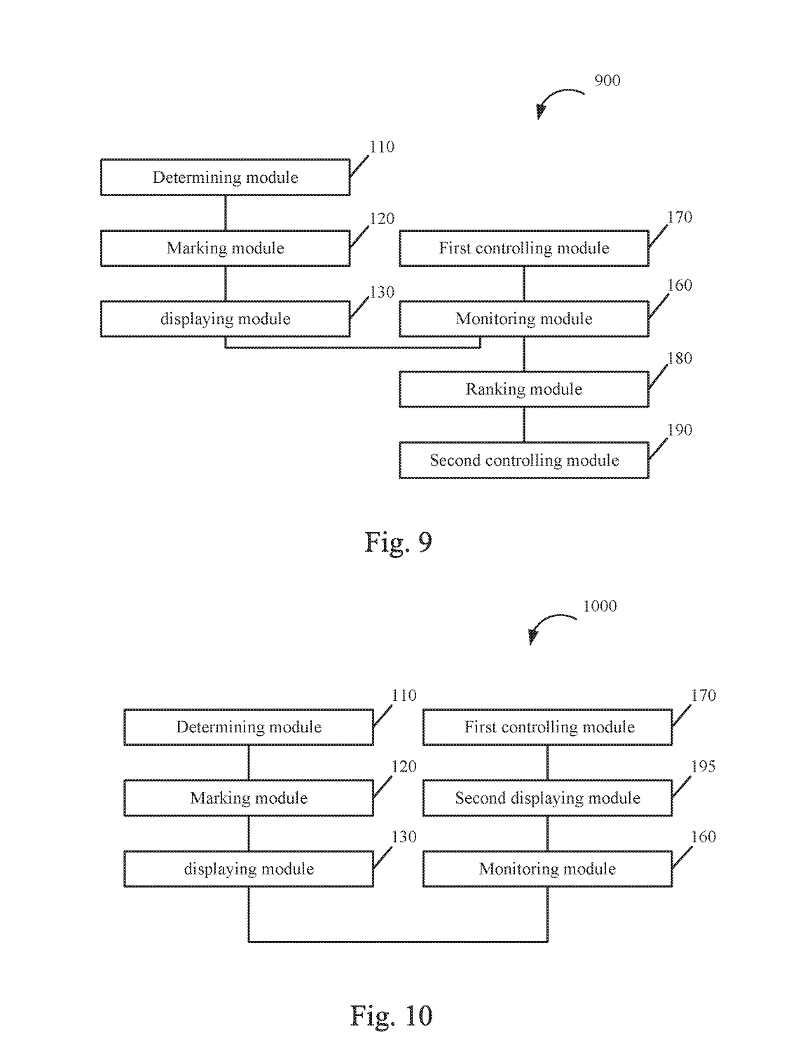

FIG. 9 is a block diagram of apparatus 900 for displaying a WiFi signal icon on a mobile terminal, according to another exemplary embodiment. This exemplary embodiment is based on the above-described exemplary embodiment shown in FIG. 8. As shown in FIG. 9, the above apparatus 900 may further include a ranking module 180 and a second controlling module 190.

The ranking module 180 is configured to, when it is monitored that there are a plurality of WiFi networks having security levels higher than the security level of the current WiFi network, rank the plurality of WiFi networks in an order of the security levels from high to low.

The second controlling module 190 is configured to control the mobile terminal to connect to a target WiFi network according to a user selection instruction. The user selection instruction includes an identity of the target WiFi network.

FIG. 10 is a block diagram of an apparatus 1000 for displaying a WiFi signal icon on a mobile terminal, according to another exemplary embodiment. This exemplary embodiment is based on the above-described exemplary embodiment shown in FIG. 8. As shown in FIG. 10, the apparatus 1000 may further include a second displaying module 195.

The second displaying module 195 is configured to, before the first controlling module 170 controls the mobile terminal to connect to the WiFi network having the highest security level currently, display prompt information indicating whether to connect to the WiFi network having the highest security level currently.

With respect to the apparatuses in the above exemplary embodiments, the specific manners for performing operations for individual modules therein have been described in detail in the exemplary embodiments regarding the methods, which will not be repeated herein.

For the apparatus embodiments, since they substantially correspond to the method embodiments, the relevant contents may be referred to some explanations in the method embodiments. The above-described apparatus embodiments are only illustrative. The modules illustrated as separate components may be or may not be separated physically. The component illustrated as a module may be or may not be a physical module, i.e., may be located at one location, or may be distributed into multiple network modules. A part or all of the modules may be selected to achieve the purpose of the solution in the present disclosure according to actual requirements. The person skilled in the art can understand and implement the present disclosure without paying inventive labor.

Correspondingly, the present disclosure also provides a mobile terminal. The mobile terminal may include the apparatuses described in the above exemplary embodiments.

The mobile terminal provided by the present embodiment determines a security level of a current WiFi network, marks a WiFi signal icon by applying a color corresponding to the security level, and displays the marked WiFi signal icon. In this way, the WiFi signal icon is displayed with a color corresponding to the security level of the WiFi network, which facilitates the user to know the security level of the currently connected network via the color of the WiFi network icon, and further facilitates the user to perform relevant operations on the mobile terminal according to the security level of the network. As a result, leaking of private information in the mobile terminal can be prevented.

In some embodiments, the present disclosure provides a mobile terminal including a processor and a memory for storing instructions executable by the processor. The processor is configured to determine a security level of a current WiFi network, mark a WiFi signal icon according to a color corresponding to the security level, and display the marked WiFi signal icon.

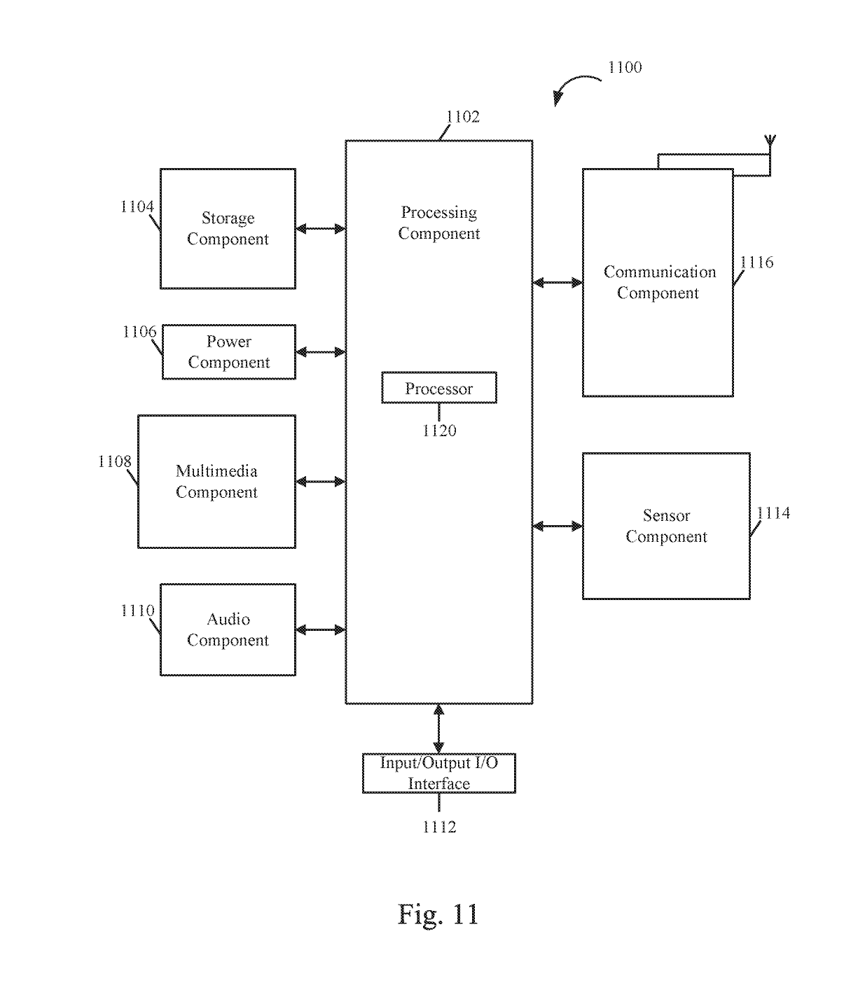

FIG. 11 is a block diagram of a mobile terminal 1100, according to an exemplary embodiment. For example, the mobile terminal 1100 may be a mobile phone, a computer, a digital broadcast terminal, a messaging device, a gaming console, a tablet, a medical device, exercise equipment, a personal digital assistant, and/or the like.

Referring to FIG. 11, the mobile terminal 1100 may include one or more of the following components: a processing component 1102, a storage component 1104, a power component 1106, a multimedia component 1108, an audio component 1110, an input/output (I/O) interface 1112, a sensor component 1114, and a communication component 1116.

The processing component 1102 typically controls overall operations of the mobile terminal 1100, such as operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate interactions between the processing component 1102 and other components. For instance, the processing component 1102 may include a multimedia module to facilitate the interactions between the multimedia component 1108 and the processing component 1102.

The storage component 1104 is configured to store various types of data to support operations of the mobile terminal 1100. Examples of such data include instructions for any applications or methods operated on the mobile terminal 1100, contact data, phonebook data, messages, pictures, video, etc. The storage component 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the mobile terminal 1100. The power component 1106 may include a power management system, one or more power sources, and any other components associated with the generation, management, and distribution of power in the mobile terminal 1100.

The multimedia component 1108 includes a screen providing an output interface between the mobile terminal 1100 and a user. In some embodiments, the screen may include a liquid crystal display (LCD) and/or a touch panel (TP). If the screen includes the touch panel, the screen may be implemented as a touch screen to receive input signals from the user. The touch panel may include one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 may include a front camera and/or a rear camera. The front camera and/or the rear camera may receive an external multimedia datum while the mobile terminal 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone (“MIC”) configured to receive an external audio signal when the mobile terminal 1100 is in an operation mode, such as a call mode, a recording mode, and/or a voice recognition mode. The received audio signal may be further stored in the storage component 1104 or transmitted via the communication component 1116. In some embodiments, the audio component 1110 may further include a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 may include one or more sensors to provide status assessments of various aspects of the mobile terminal 1100. For instance, the sensor component 1114 may detect an open/closed status of the mobile terminal 1100, relative positioning of components, e.g., the display and the keypad, of the mobile terminal 1100, a change in position of the mobile terminal 1100 or a component of the mobile terminal 1100, a presence or absence of user contact with the mobile terminal 1100, an orientation or an acceleration/deceleration of the mobile terminal 1100, and/or a change in temperature of the mobile terminal 1100. The sensor component 1114 may include a proximity sensor configured to detect the presence of nearby objects without any physical contact. The sensor component 1114 may also include a light sensor, such as a CMOS or CCD image sensor, for imaging applications. In some embodiments, the sensor component 1114 may also include an accelerometer sensor, a gyroscope sensor, a magnetic sensor, a pressure sensor, or a temperature sensor.

The communication component 1116 is configured to facilitate wired or wireless communications, between the mobile terminal 1100 and other devices. The mobile terminal 1100 can access a wireless network based on a communication standard, such as WiFi, 2G or 3G or a combination thereof. In one exemplary embodiment, the communication component 1116 receives a broadcast signal from an external broadcast management system via a broadcast channel or broadcast associated information. In one exemplary embodiment, the communication component 1116 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the mobile terminal 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In some embodiments, a non-transitory computer-readable storage medium having instructions stored thereon is provided, such as instructions stored on the storage component 1104. The instructions are executable by the processor 1120 in the mobile terminal 1100, for performing the above-described methods. For example, the non-transitory computer-readable storage medium may be a ROM, a RAM, a CD-ROM, a magnetic tape, a floppy disc, an optical data storage device, and the like.

The instructions stored on the non-transitory computer readable storage medium, when executed by the processor 1120 of the mobile terminal 1100, cause the mobile terminal 1100 to perform the above methods for displaying a WiFi signal icon on a mobile terminal.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for displaying a WiFi signal icon on a mobile terminal, comprising:
determining a security level of a current WiFi network;
marking a WiFi signal icon according to a color corresponding to the security level; and
displaying the marked WiFi signal icon on the mobile terminal.

2. The method of claim 1, wherein the determining the security level of the current WiFi network comprises:
searching for the security level of the current WiFi network from a prestored corresponding relationship between networks and security levels.

3. The method of claim 2, wherein after searching for the security level of the current WiFi network, the method further comprises:
when the security level of the current WiFi network is not found, displaying a current security level input box; and
storing the current WiFi network and a current security level associatively according to an instruction from the current security level input box, the instruction including the current security level.

4. The method of claim 1, further comprising:
monitoring whether there is a second WiFi network having a second security level higher than the security level of the current WiFi network; and
when there is the second WiFi network having the second security level higher than the security level of the current WiFi network, controlling the mobile terminal to connect to the second WiFi network.

5. The method of claim 4, wherein when it is determined that there are a plurality of WiFi networks having security levels higher than the current WiFi network, the method further comprises:
ranking the plurality of WiFi networks in an order of the security levels from high to low; and
controlling the mobile terminal to connect to a target WiFi network selected from the plurality of WiFi networks according to a selection instruction, the selection instruction including an identity of the target WiFi network.

6. The method of claim 4, wherein before controlling the mobile terminal to connect to the second WiFi network, the method further comprises:
displaying prompt information indicating whether to connect to the second WiFi network.

7. A mobile terminal, comprising:
a processor; and
a memory for storing instructions executable by the processor;
wherein the processor is configured to:
determine a security level of a current WiFi network;
mark a WiFi signal icon according to a color corresponding to the security level; and
display the marked WiFi signal icon.

8. The mobile terminal of claim 7, wherein the processor is further configured to:
Search for the security level of the current WiFi network from a prestored corresponding relationship between networks and security levels.

9. The mobile terminal of claim 8, wherein the processor is further configured to:
when the security level of the current WiFi network is not found, display a current security level input box; and
store the current WiFi network and a current security level associatively according to an instruction from the current security level input box, the instruction including the current security level.

10. The mobile terminal of claim 7, wherein the processor is further configured to:
monitor whether there is a second WiFi network having a second security level higher than the security level of the current WiFi network; and
when there is the second WiFi network having the second security level higher than the security level of the current WiFi network, control the mobile terminal to connect to the second WiFi network.

11. The mobile terminal of claim 10, wherein the processor is further configured to:
when it is determined that there are a plurality of WiFi networks having security levels higher than the security level of the current WiFi network, rank the plurality of WiFi networks in an order of the security levels from high to low; and
control the mobile terminal to connect to a target WiFi network selected from the plurality of WiFi networks according to a selection instruction, the selection instruction including an identity of the target WiFi network.

12. The mobile terminal of claim 10, wherein the processor is further configured to:
before controlling the mobile terminal to connect to the second WiFi network, display prompt information indicating whether to connect to the second WiFi network.

13. A non-transitory computer-readable storage medium having stored therein instructions that, when executed by a processor in a mobile terminal, cause the mobile terminal to perform a method for displaying a WiFi signal icon on the mobile terminal, the method comprising:
determining a security level of a current WiFi network;
marking a WiFi signal icon according to a color corresponding to the security level; and
displaying the marked WiFi signal icon on the mobile terminal.

14. The non-transitory computer-readable storage medium of claim 13, wherein the determining the security level of the current WiFi network comprises:
searching for the security level of the current WiFi network from a prestored corresponding relationship between networks and security levels.

15. The non-transitory computer-readable storage medium of claim 14, wherein after searching for the security level of the current WiFi network, the method further comprises:
when the security level of the current WiFi network is not found, displaying a current security level input box; and
storing the current WiFi network and a current security level associatively according to an instruction from the current security level input box, the instruction including the current security level.

16. The non-transitory computer-readable storage medium of claim 13, wherein the method further comprises:
monitoring whether there is a second WiFi network having a second security level higher than the security level of the current WiFi network; and
when there is the second WiFi network having the second security level higher than the security level of the current WiFi network, controlling the mobile terminal to connect to the second WiFi network.

17. The non-transitory computer-readable storage medium of claim 16, wherein when it is determined that there are a plurality of WiFi networks having security levels higher than the current WiFi network, the method further comprises:
ranking the plurality of WiFi networks in an order of the security levels from high to low; and
controlling the mobile terminal to connect to a target WiFi network selected from the plurality of WiFi networks according to a selection instruction, the selection instruction including an identity of the target WiFi network.

18. The non-transitory computer-readable storage medium of claim 16, wherein before controlling the mobile terminal to connect to the second WiFi network, the method further comprises:
displaying prompt information indicating whether to connect to the second WiFi network.
